(19) United States
(12) Patent Application Publication
(10) Pub. No.: US 2004/0024695 A1
(43) Pub. Date: Feb. 5, 2004

(54) Constant volatility or risk indices

(75) Inventor: Nitzan Melamed, New York, NY (US)

Correspondence Address: Hale and Dorr LLP, 1455 Pennsylvania Avenue, N.W., Washington, DC, 20004, US

(73) Assignee: RiskMetrics Group, Inc.

(21) Appl. No.: 10/620,444

(22) Filed: Jul. 17, 2003

Related U.S. Application Data
(60) Provisional application No. 60/397,145, filed on Jul. 19, 2002.

(51) Int. Cl. G06F 17/60

(52) U.S. Cl. 705/38

(57) ABSTRACT

A technique for implementing a financial instruments index maintains the level of volatility or risk associated with the index at a specified level. Specifically, the technique includes establishing a level of risk at which a risk associated with the index is to be maintained. In at least some embodiments, the level of risk may be quantified using one or more of RiskMetric Group's RiskGrade measure, standard deviation, variance, average shortfall, VAR, or any other similar or analogous measures. Once the desired level of risk has been established, the technique monitors the level of risk associated with the index for fluctuations. If detected, the technique rebalances the index by reallocating index components. More particularly, when the risk associated with the index exceeds the desired level of risk by more than a predetermined limit, assets from relatively high risk components of the index are reallocated to relatively low risk components of the index. Likewise, when the risk associated with the index drops below the desired level of risk by more than a predetermined limit, assets from relatively low risk components of the index are reallocated to relatively high risk components of the index. In this manner, the risk level associated with the index may be maintained.

### CROSS REFERENCE TO RELATED APPLICATION

This application claims the benefit of U.S. Provisional Applications 60/397,145, filed on Jul. 19, 2002, which is incorporated herein by reference.

### FIELD OF THE INVENTION

The present invention relates generally to financial investment services. More particularly, the present invention relates to techniques for implementing financial instruments indices with constant levels of risk or volatility.

### BACKGROUND OF THE INVENTION

Financial indices often attempt to represent individual markets, segments of markets, asset classes, industries, etc. Examples include the S&P 500, the Wilshire 5000, the AMEX Major Market Index, the Russell 2000 Index, the Nasdaq 100, EAFE Index, and many others. The S&P 500 represents the large capitalization asset class in the U.S.; the Nasdaq 100 represents the technology and telecommunications industries; and the EAFE Index represents the European, Asian, and Far East markets. The components of these indices remain fairly constant, and undergo only occasional changes. They may change when there is a need to represent a market, asset class, or industry in a more accurate manner. For example, the S&P 500 deletes, from time to time, securities which cease to be large cap stocks, and hence do not represent the large cap asset class in the U.S.

One factor that is often considered in conjunction with these indices includes the amount of risk the indices are associated with. Thus, numerous techniques have been developed to allow risk quantification. Specific examples have traditionally included standard deviation, average shortfall, and variance. In addition to these, another example includes the “value-at-risk” (“VAR”) measure. The VAR of, for example, an individual investor's portfolio indicates the portfolio's market risk by describing the greatest possible loss that may be expected in the portfolio in question (based upon its contents, which can include one or more indices or portions thereof) with a certain given degree of probability during a certain future period of time.

Nevertheless, many problems remain in the prior art. For instance, the amount of risk associated with an index or individual security (or any other potential investment-type component) may not always remain constant over time. To the contrary, the risk level associated with an index typically fluctuates greatly depending upon any number of factors. Events or circumstances such as volatile market conditions can and often do cause dramatic changes in the levels of risk associated with an index. For example, one of the more popular measures of expected U.S. stock market risk is the VIX index (i.e., an index designed to track market volatility), which in 2002 ranged from a low of 20 to a high of 50.

As a result, in order to maintain a constant risk level, an investor must diligently monitor his or her portfolio. Changes in the market conditions of a particular industry may require investors to continually rebalance their portfolios in a manner that replaces securities from that industry with securities from another industry, or in a manner that replaces securities with risk-free assets, such as cash, in order to maintain their ideal or desired risk level. With investors who invest in financial indices, the procedure includes changing the amount invested in the indices as the indices' risk changes.

While occasionally rebalancing a portfolio may be possible, in many cases it may not be practical. For instance, transaction costs and taxation associated with the reallocation of assets may make rebalancing to maintain a constant risk level impossible or so costly as to be impractical. Likewise, most investors simply do not have the time and resources to constantly manage and monitor a portfolio. The end result of all this is that many investors carry portfolios with fluctuating risk that do not often fit their risk appetite. As a result, an investor may find that his or her investments in a particular portfolio, while satisfactory to begin with, are no long suitable. Accordingly, increasingly efficient techniques for structuring indices, specifically indices that consider risk or volatility, are needed.

### SUMMARY OF THE INVENTION

The present invention addresses the problems described above with a specified risk or volatility index. More specifically, a financial instruments index is implemented such that the level of volatility or risk associated with the index is kept or maintained at a specified level. Initially, a level of risk at which a risk associated with the index is to be maintained is established. Subsequently, the level of risk associated with the index is monitored. If the risk associated with the index exceeds the desired level of risk by more than a predetermined limit, assets from relatively high risk components of the index are reallocated to relatively low risk components of the index. Likewise, if the risk associated with the index drops below the desired level of risk by more than a predetermined limit, assets from relatively low risk components of the index are reallocated to relatively high risk components of the index. In this manner, the risk level associated with the index may be maintained.

In one or more parallel and at least somewhat overlapping embodiments, the level of risk may be quantified using one or more of RiskMetric Group's RiskGrade measure (available from RiskMetrics Group of New York, N.Y.), value-at-risk (VAR), variance, average shortfall, standard deviation, or any other similar or analogous measures.

### BRIEF DESCRIPTION OF THE DRAWINGS

Various objects, features, and advantages of the present invention can be more fully appreciated as the same become better understood with reference to the following detailed description of the present invention when considered in connection with the accompanying drawings, in which:

FIG. 1 depicts at least one example of a process utilizable for implementing a constant volatility index of the present invention;

FIG. 2 depicts at least one example of a process utilizable for maintaining a risk level of the constant volatility index of the present invention;

FIG. 3 depicts at least one example of a process utilizable for decreasing a risk level associated with the constant volatility index of the present invention;

FIG. 4 depicts at least one example of a process utilizable for increasing a risk level associated with the constant volatility index of the present invention;

FIG. 5 is a high-level block diagram depicting aspects of computing devices contemplated as part of, and for use with at least some, embodiments of the present invention; and

FIG. 6 illustrates one example of a memory medium which may be used for storing a computer implemented process of at least some embodiments of the present invention.

### DETAILED DESCRIPTION OF THE INVENTION

In accordance with at least some embodiments of the present invention, a technique is provided for implementing a financial instruments index that maintains the level of volatility or risk associated with the index at a constant level (or within a specified range). The following description provides one example of an implementation of the technique of the present invention.

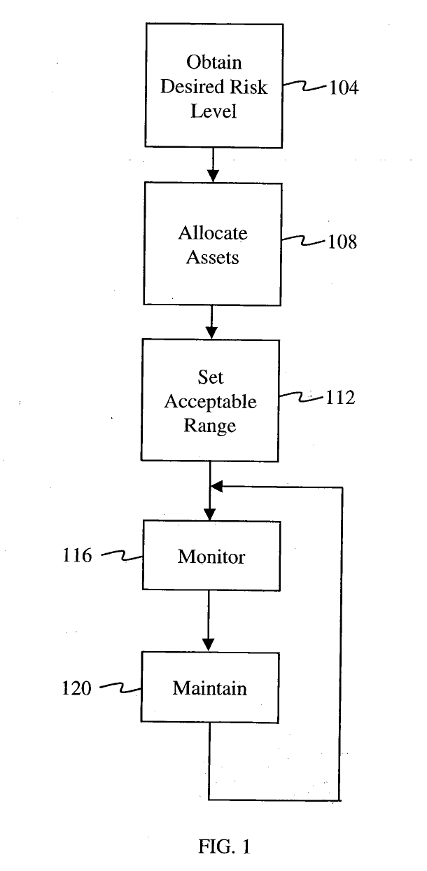

FIG. 1 illustrates at least one example of a process utilizable for implementing the constant risk index of the present invention. Initially, the process commences by obtaining a desired or target risk or volatility level (i.e., the tendency of an investment to rise or fall sharply within a set period of time) for an individual index (i.e., a composite of securities that serves as a barometer for the overall market or some segment of it)(STEP 104).

The target risk level may be set arbitrarily depending on the specific needs and requirements of the index provider. For example, embodiments of the present invention contemplate that an indices provider, such as Dow Jones & Company or Standard and Poor, may utilize the techniques of the present invention to implement and offer any number of constant risk indices to its customers. More particularly, the indices provider may utilize the techniques of the present invention to implement and offer constant volatility indices that target, for example, RiskGrades of 30, 60, 90, 120, and 150, thereby allowing individual investors to invest in the most suitable index depending on their individual needs (i.e., risk aversion).

As one specific example, using the RiskGrade™ statistic, the target risk level associated with a constant risk index of the present invention may be set to 70, indicating that the index is less risky or volatile than the market-cap weighted average volatility of international markets during normal market conditions.

After defining a risk level (STEP 104), processing continues with the allocation of assets required to obtain the identified risk level (STEP 108). One example of a method for allocating assets, from a predetermined set of assets, in order to achieve a predetermined risk level, can be described in three simple steps:

1. Find the relative proportions allocated to the risky assets, based on their observed market capitalization.

2. Calculate the risk of a portfolio that contains only the risky set of assets using the proportions calculated in Step 1.

3. Calculate the weight of investment between: a) the risk calculated in Step 2 and b) zero (for the risk of a risk-free asset) to achieve the desired risk level.

As one example, in which the target risk level to achieve is a RiskGrade™ of 20, a set of assets includes 2 risky assets, A and B, and a risk-free asset, C. The observed market caps of assets A and B are 25 million dollars and 75 million dollars respectively. This implies that the index will include a holding ratio of 1:3 between assets A and B. As Step 1 indicates, a portfolio that contains $1 in Asset A, and $3 in Asset B should be created. Step 2 calculates the risk of this portfolio ($1 in A and $3 in B). Assume this risk was calculated to be a RiskGrade™ of 100. In Step 3, the weights between the risky portfolio and the risk-free (Asset C) that leads to the target level of RiskGrade™ may be determined. The weights of the risky portfolio (ratio of 1:3 in holdings between A and B) and the risk free asset (C) should be 20% and 80% respectively (20%×100+80%×0=20). Thus in this example, the overall index allocation is: 5% Asset A, 15% Asset B, and 80% Asset C.

Another way to find how much to invest in each asset from a predetermined set of assets in order to achieve a predetermined risk level includes using a simple mathematical maximization problem to find the portfolio that has the highest expected return for a given preset variance for the portfolio (the target risk level). The solution assigns a weight to be invested in each asset, and assures the overall target risk for the portfolio.

While two specific examples for allocating assets are provided above, it is to be understood that embodiments of the present invention contemplate utilizing any allocation method so long as the overall risk level of the index comports with the target risk level determined at, for example, STEP 104 above. Thus, the components of the index of the present invention may include any number and combination of assets, including, for example, any number of individual securities, combinations of securities including other financial indices (e.g., the S&P 500), bonds, cash, etc.

Hence, any combination of assets, including for example the inclusion of any single or combination of financial indices (e.g., the S&P 500, Dow, MSCI, FT, etc.), any single or combination of securities, bonds, etc., and cash may constitute the components of the constant volatility index of the present invention (so long as the overall risk level of the composite index comports with the targeted risk level). Furthermore, at least some embodiments of the present invention contemplate the use of internally generated and non-branded indices. Thus, with the above example, the S&P 500 may constitute a certain percentage of the constant volatility index of the present invention (e.g., 80%), with the remainder (e.g., 20%) of the index being made up of cash, so long as the overall risk level of the composite index comports with the targeted risk level (e.g., RiskGrade of 70).

After allocating assets (STEP 108), an acceptable risk range is established (STEP 112). At least some embodiments of the present invention contemplate that the range of acceptable risk indicates that range of risk in which fluctuations are acceptable, and in which rebalancing or reallocation is not required. Thus, to allow for all degrees of precision, any range of risk is acceptable. With the example above (i.e., RiskGrade of 70), the index provider may set a lower acceptable risk of a RiskGrade of 60 and a higher acceptable risk of a RiskGrade of 80, resulting in a range of acceptable risk or “risk band” of 20. In any event, the range of acceptable risk may be set arbitrarily depending on the needs and the requirements of the index provider. For example, a larger range, as will be discussed in greater detail below, may result in fewer instances of rebalancing. Furthermore, at least some embodiments of the present invention contemplate that any deviations from the target risk is unacceptable (i.e., no range at all).

Subsequently, the index is monitored (STEP 116). More precisely, an index provider, for example, monitors the risk (and any changes associated therewith) of the index by recalculating the level of risk associated with the index and comparing with acceptable ranges. At least some embodiments of the present invention contemplate that the index may be monitored periodically over predetermined time intervals. For example, at least some embodiments of the present invention contemplate monitoring the index every seven days (i.e., once a week). Other embodiments contemplate monitoring the risk of the index every month. Thus, embodiments of the present invention contemplate that any monitoring time periods may be utilized including, for example, bi-weekly, every three days, every seventeen days, twice a month, hourly, fractions of days, etc. As will be discussed below, the risk level of the index is monitored to allow it to be maintained within predetermined acceptable levels.

In conjunction with monitoring the risk of the index (STEP 116), the process also maintains the risk level of the index (STEP 120). As will be discussed in greater detail below, at least some embodiments of the present invention contemplate maintaining the risk level by shifting assets between relatively high and relatively low risk index components as their relative risks change. In this manner, the level of risk associated with the index may be maintained at a relatively constant level. Thus, investor portfolios that include allocations to the constant volatility index of the present invention similarly remain at a constant risk level.

An example of at least one technique that may be utilized in conjunction with embodiments of the present invention for quantifying and measuring risk includes the RiskGrade™ statistic, devised and offered by RiskMetrics Group of New York, N.Y., the details of which may be found in Kim, RiskGrades™ Technical Document, RiskMetrics Group, New York, N.Y. (2000), which is incorporated herein by reference. Generally speaking, the RiskGrade™ statistic is a standardized measure of volatility, and hence allows an “apples to apples” direct comparison of investment or asset risk across all asset classes and regions. The RiskGrade™ statistic is calculated by comparing the current estimate of an asset's return volatility to the market-cap weighted average return volatility of a diverse set of international equity markets during normal market conditions. This ratio results in the RiskGrade measure, which may vary from 0, for cash, to values well in excess of 1000, for highly speculative investments, with 100 corresponding to the market-cap weighted average volatility of international markets during normal market conditions. Thus, as an example, using the RiskGrade™ statistic a Brazilian stock with a RiskGrade of 300 may be deemed six times as risky as an Asian Bond Fund with a RiskGrade of 50.

Another example of a risk quantification technique utilizable with the constant risk index of the present invention includes standard deviation. For example, a typical standard deviation of the S&P 500 ranges from about 15% to 20%. A standard deviation higher than this implies greater volatility than the S&P 500.

Although the examples above describe the utilization of the RiskGrade™ statistic and standard deviation in the generation of the constant risk index of the present invention, it is to be understood that at least some embodiments of the present invention contemplate using other risk quantification techniques. For instance, at least some embodiments of the present invention contemplate using any of an average shortfall, beta, variance, VAR, or any other similar or analogous measures, instead of the RiskGrade measure or standard deviation to quantify risk.

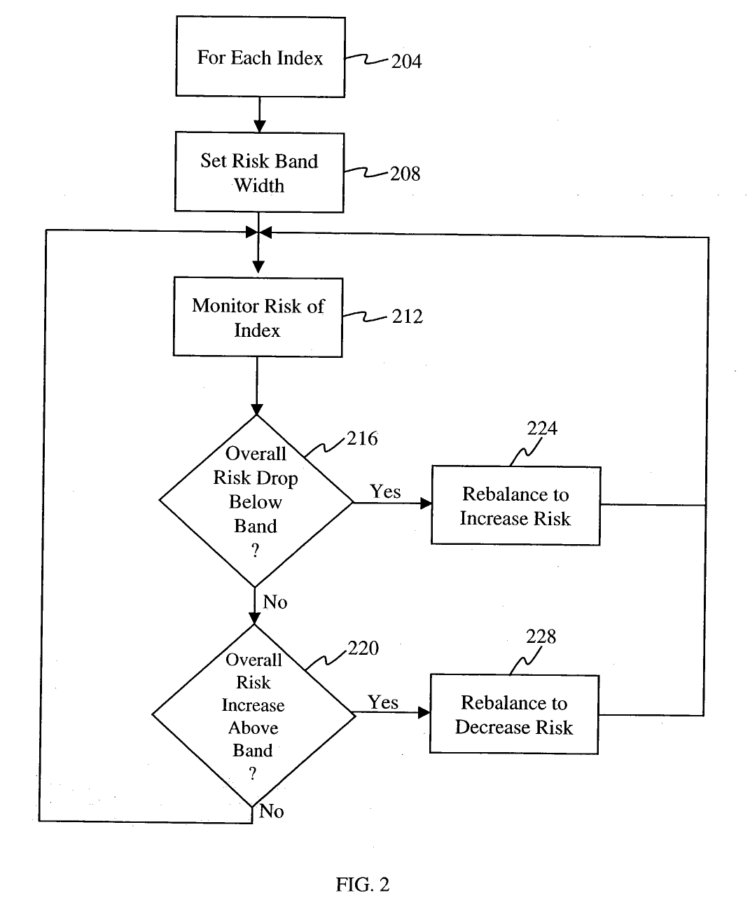

Referring now to FIG. 2, one example of a process utilizable for maintaining a risk level of a constant volatility index of the present invention is depicted. As contemplated by at least some embodiments of the present invention, any number of constant risk level indices for various risk levels may be implemented. For example, an indices provider (e.g., Dow Jones & Company) may utilize the techniques of the present invention to implement and offer a family of constant volatility indices, including a low level risk index, a moderate level risk index, and a high level risk index for its customers. Thus, it should be clear that any and all ranges of risk are contemplated as being included within embodiments of the present invention. Whatever the case, for each index (STEP 204), a range of acceptable risk is first determined (STEP 208). As discussed above, this range of acceptable risk indicates that range of risk in which fluctuations are acceptable, and in which rebalancing or reallocation is not required. As an example, the level of acceptable risk may range from a RiskGrade of 60 to a RiskGrade of 80 for a RiskGrade target of 70.

From there, the components of the index and the index risk may be determined in the manner described above. Subsequently, the risk of the index is monitored (STEP 212). In particular, the process monitors the overall risk of the index for overall risk increases as well as decreases that elevate or drop the risk level above or below acceptable limits. Thus, to maintain the risk within these limits, at least some of the embodiments of the present invention contemplate varying the weights of assets of the index as its risk changes.

More specifically, if the overall risk of the index drops below the level of acceptable risk (STEP 216), the index is rebalanced to increase the risk (STEP 224). Thus, in the example presented above, if the risk of the index drops below a RiskGrade of 60, the process executes a rebalancing procedure to increase the level of risk associated with the index to a RiskGrade of at least 60.

On the other hand, if the overall risk of the index rises above the level of acceptable risk (STEP 220), the index is rebalanced to decrease the risk (STEP 228). Thus, in the example presented above, if the RiskGrade of the index rises above 80, the process executes a rebalancing procedure to decrease the level of risk associated with the index to a RiskGrade that is less than 80.

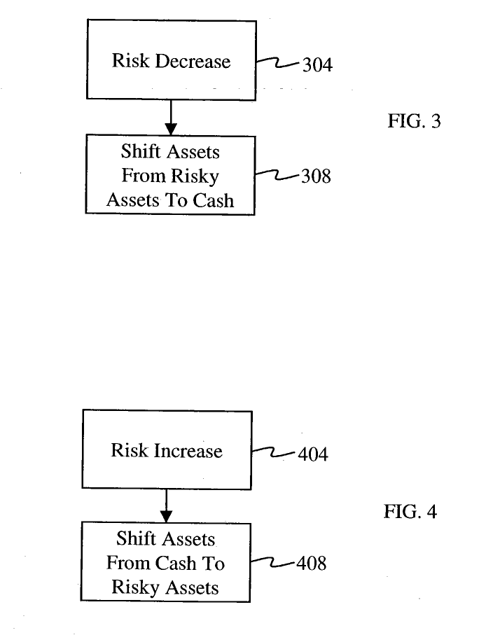

As mentioned above, changes in the level of risk that exceed the range of acceptable limits are addressed by rebalancing or reallocating the components of the index, with the goal of returning the risk to within acceptable limits. Specifically, FIG. 3 depicts one example of a process utilizable for decreasing the risk associated with a constant volatility index of the present invention (STEP 304). In particular, to reduce the risk associated with an index, assets or components of the index may be shifted from relatively risky assets to relatively risk free assets (STEP 308). As an example, assets allocated to securities may be shifted to lower risk assets such as short or long-term bonds, cash, TIPS, or any other risk free assets. Similarly, assets allocated to securities may be shifted to lower risk securities as well.

In situations where the level of risk associated with an index drops below an acceptable level, embodiments of the present invention contemplate elevating the level of risk of the index. One example of such a process utilizable for elevating the risk associated with an index is depicted in FIG. 4. Specifically, to increase the risk associated with an index (STEP 404), assets or components of the index may be shifted from relatively low risk or risk free assets to relatively high risk or risky assets (STEP 408). For example, risk free (or risk free-like) or low risk assets may be shifted to high risk assets such as stock. Similarly, instead of focusing on cash, assets allocated to securities may be shifted to higher risk securities as well.

Furthermore, although the examples above describe shifting between securities and cash or bonds, it is to be understood that at least some embodiments of the present invention contemplate shifting assets between similar types of assets that carry differing levels of risk. For example, to reduce risk, at least some embodiments of the present invention contemplate shifting assets from high risk securities to lower risk securities. Similarly, at least some embodiments of the present invention contemplate increasing risk by shifting assets from cash to bonds or other low risk, non-stock investments.

As to reallocating or rebalancing assets, embodiments of the present invention contemplate that any suitable rebalancing targeting procedures may be utilized. As an example, once the level of risk associated with the index drifts outside the acceptable range of risk, the composition of the index may be rebalanced targeting the original target risk (i.e., the center of the band). Thus, using the above example, with an acceptable range of a RiskGrade of 60 to a RiskGrade of 80 with a RiskGrade target of 70, if the risk level associated with the index exceeds 80, it is rebalanced (i.e., by reallocating assets) targeting a RiskGrade of 70.

As another example, more aggressive rebalancing techniques may just as easily be implemented. For instance, instead of targeting the original target (i.e., the center of the band), embodiments of the present invention contemplate targeting a target residing beyond the original target. Specifically, one embodiment contemplates targeting a target determined according to the following:

Targeted Risk=Band Center−Band Range/4.

Thus, using the above example, with an acceptable range of a RiskGrade of 60 to a RiskGrade of 80 with a RiskGrade target of 70, if the risk level associated with the index attains 88, it is rebalanced (i.e., by reallocating assets) targeting a RiskGrade of 65 (70−[20/4]=65).

Furthermore, although two examples of rebalancing are described above, it is to be understood that embodiments of the present invention contemplate utilizing any rebalancing techniques, so long as the desired risk level is targeted.

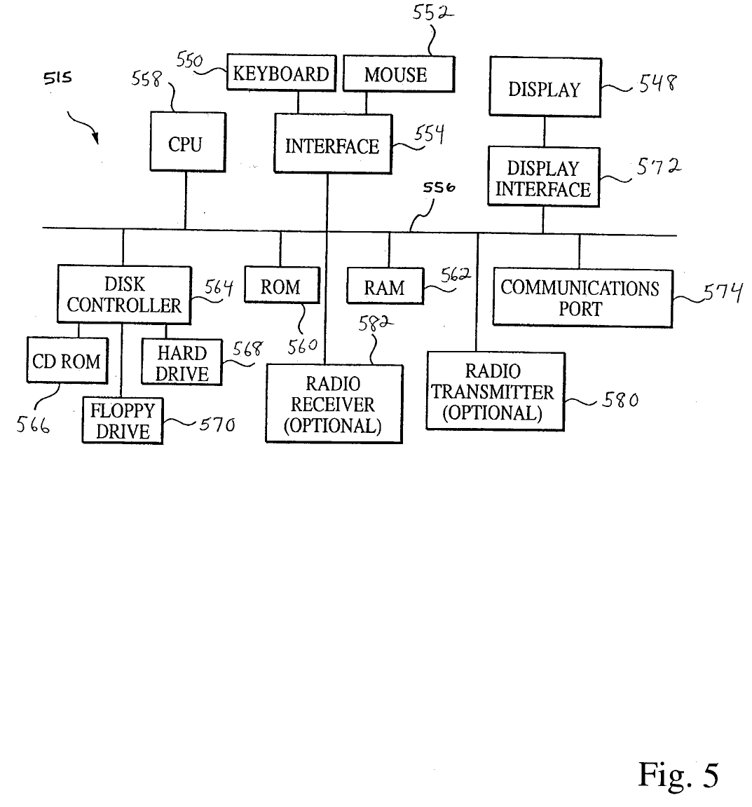

At least some embodiments of the present invention contemplate that the constant risk indices may be implemented in any computer system or computer-based controller. One example of such a system is described in greater detail below with reference to FIG. 5. More specifically, FIG. 5 is an illustration of a computer system 515 used for implementing the computer processing in accordance with a computer-implemented embodiment of the present invention. The procedures described above may be presented in terms of program procedures executed on, for example, a computer or network of computers.

FIG. 5 illustrates a block diagram of one example of the internal hardware of system 515, examples of which include any of a number of different types of computers such as those having Pentium™ based processors as manufactured by Intel Corporation of Santa Clara, Calif. A bus 556 serves as the main information link interconnecting the other components of system 515. CPU 558 is the central processing unit of the system, performing calculations and logic operations required to execute the processes of the instant invention as well as other programs. Read only memory (ROM) 560 and random access memory (RAM) 562 constitute the main memory of the system. Disk controller 564 interfaces one or more disk drives to the system bus 556. These disk drives are, for example, floppy disk drives 570, or CD ROM or DVD (digital video disks) drives 566, or internal or external hard drives 568. CPU 558 can be any number of different types of processors, including those manufactured by Intel Corporation or Motorola of Schaumberg, Ill. The memory/storage devices can be any number of different types of memory devices such as DRAM and SRAM as well as various types of storage devices, including magnetic and optical media. Furthermore, the memory/storage devices can also take the form of a transmission.

A display interface 572 interfaces display 548 and permits information from the bus 556 to be displayed on display 548. Display 548 is also an optional accessory. Communications with external devices such as the other components of the system described above, occur utilizing, for example, communication port 574. Optical fibers and/or electrical cables and/or conductors and/or optical communication (e.g., infrared, and the like) and/or wireless communication (e.g., radio frequency (RF), and the like) can be used as the transport medium between the external devices and communication port 574. Peripheral interface 554 interfaces the keyboard 550 and mouse 552, permitting input data to be transmitted to bus 556. In addition to these components, the control system also optionally includes an infrared transmitter 578 and/or infrared receiver 576. Infrared transmitters are optionally utilized when the computer system is used in conjunction with one or more of the processing components/stations that transmits/receives data via infrared signal transmission. Instead of utilizing an infrared transmitter or infrared receiver, the control system may also optionally use a low power radio transmitter 580 and/or a low power radio receiver 582. The low power radio transmitter transmits the signal for reception by components of the production process, and receives signals from the components via the low power radio receiver.

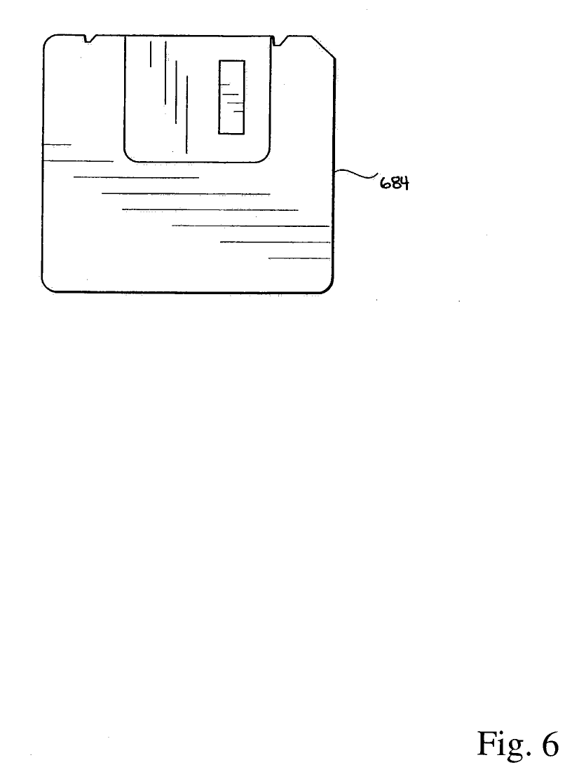

FIG. 6 is an illustration of an exemplary computer readable memory medium 884 utilizable for storing computer readable code or instructions including the model(s), recipe(s), etc). As one example, medium 684 may be used with disk drives illustrated in FIG. 5. Typically, memory media such as floppy disks, or a CD ROM, or a digital video disk will contain, for example, a multi-byte locale for a single byte language and the program information for controlling the above system to enable the computer to perform the functions described herein. Alternatively, ROM 560 and/or RAM 562 can also be used to store the program information that is used to instruct the central processing unit 558 to perform the operations associated with the instant processes. Other examples of suitable computer readable media for storing information include magnetic, electronic, or optical (including holographic) storage, some combination thereof, etc. In addition, at least some embodiments of the present invention contemplate that the computer readable medium can be a transmission.

At least some embodiments of the present invention contemplate implementing the techniques of the present invention in a computer system in a manner such that the information used to quantify the risk of the index assets (e.g., information used in STEPS 108, 116 or 120) is inputted via keyboard 550 or downloaded via port 574. From there, software implemented in, for example, CPU 558 may be utilized to generate the constant risk index of the present invention, which in turn may be displayed onto display 548.

At least some embodiments of the present invention contemplate that various portions of software for implementing the various aspects of the present invention as previously described can reside in the memory/storage devices.

In general, it should be emphasized that the various components of embodiments of the present invention can be implemented in hardware, software, or a combination thereof. In such embodiments, the various components and steps would be implemented in hardware and/or software to perform the functions of the present invention. Any presently available or future developed computer software language and/or hardware components can be employed in such embodiments of the present invention. For example, at least some of the functionality mentioned above could be implemented using C or C++ programming languages.

It is also to be appreciated and understood that the specific embodiments of the invention described hereinbefore are merely illustrative of the general principles of the invention. Various modifications may be made by those skilled in the art consistent with the principles set forth hereinbefore.

We claim:

1. A computer-implemented or assisted method for implementing a constant volatility index, the index having an associated risk, said computer-implemented or assisted method comprising the steps of:
(1) establishing a target level of risk at which to maintain said index;
(2) monitoring said level of risk associated with said index; and
(3) rebalancing said index by reallocating index components when the risk associated with said index deviates from said target level of risk, thereby at least substantially maintaining a specified risk level.

2. The computer-implemented or assisted method of claim 1, further comprising implementing a risk band to delimit a lower level of risk below said target level of risk and an upper level of risk above said target level of risk of said index, and wherein said step of rebalancing comprises rebalancing said index when the risk associated with said index rises above said upper level of risk or drops below said lower level of risk, thereby at least substantially maintaining the risk associated with said index between said lower and upper levels of said risk band.

3. The computer-implemented or assisted method of claim 1, wherein said level of risk is measured using RiskMetric Group's RiskGrade measure.

4. The computer-implemented or assisted method of claim 1, wherein said level of risk is measured using at least one of standard deviation, variance, average shortfall, VAR, or any other similar or analogous measures.

5. The computer-implemented or assisted method of claim 1, wherein said step of rebalancing comprises reallocating assets from relatively high risk components of said index to relatively low risk components of said index, if the risk associated with said index exceeds said level of risk by a predetermined level.

6. The computer-implemented or assisted method of claim 1, wherein said step of rebalancing comprises reallocating assets from relatively low risk components of said index to relatively high risk components of said index, if the risk associated with said index drops below said level of risk by a predetermined level.

7. The computer-implemented or assisted method of claim 1, wherein said index components comprise at least one security and cash.

8. The computer-implemented or assisted method of claim 7, wherein said cash is shifted to said at least one security to increase risk.

9. The computer-implemented or assisted method of claim 7, wherein said at least one security is shifted to said cash to decrease risk.

10. A system for implementing a constant volatility index, the index having an associated risk, said system comprising:
an input device for accepting a target level of risk at which to maintain said index;
a device for monitoring said level of risk associated with said index; and
a processor for rebalancing said index by reallocating index components when the risk associated with said index deviates from said target level of risk, thereby at least substantially maintaining a specified risk level.

11. The system of claim 10, wherein said processor implements a risk band to delimit a lower level of risk below said target level of risk and an upper level of risk above said target level of risk of said index, and wherein said processor rebalances said index when the risk associated with said index rises above said upper level of risk or drops below said lower level of risk.

12. The system of claim 10, wherein said level of risk is measured using at least one of RiskMetric Group's RiskGrade measure, standard deviation, variance, average shortfall, VAR, or any other similar or analogous measures.

13. The system of claim 10, wherein said processor rebalances said index by reallocating assets from relatively high risk components of said index to relatively low risk components of said index when the risk associated with said index exceeds said level of risk by a predetermined level.

14. The system of claim 10, wherein said processor rebalances said index by reallocating assets from relatively low risk components of said index to relatively high risk components of said index when the risk associated with said index drops below said level of risk by a predetermined level.

15. The system of claim 10, wherein said index components comprise at least one security and cash.

16. The system of claim 15, wherein said cash is shifted to said at least one security to increase risk.

17. The system of claim 15, wherein said at least one security is shifted to said cash to decrease risk.

18. A system for implementing a constant volatility index, the index having an associated risk, said system comprising:
means for establishing a target level of risk at which to maintain said index;
means for monitoring said level of risk associated with said index; and
means for rebalancing said index by reallocating index components when the risk associated with said index deviates from said target level of risk, thereby at least substantially maintaining a specified risk level.

19. The system of claim 18, further comprising means for implementing a risk band to delimit a lower level of risk below said target level of risk and an upper level of risk above said target level of risk of said index, and wherein said means for rebalancing comprises means for rebalancing said index when the risk associated with said index rises above said upper level of risk or drops below said lower level of risk.

20. The system of claim 18, wherein said level of risk is measured using at least one of RiskMetric Group's RiskGrade measure, standard deviation, variance, average shortfall, VAR, or any other similar or analogous measures.

21. The system of claim 18, wherein said means for rebalancing comprises means for reallocating assets from relatively high risk components of said index to relatively low risk components of said index when the risk associated with said index exceeds said level of risk by a predetermined level.

22. The system of claim 18, wherein said means for rebalancing comprises means for reallocating assets from relatively low risk components of said index to relatively high risk components of said index when the risk associated with said index drops below said level of risk by a predetermined level.

23. The system of claim 18, wherein said index components comprise at least one security and cash.

24. The system of claim 23, wherein said cash is shifted to said at least one security to increase risk.

25. The system of claim 23, wherein said at least one security is shifted to said cash to decrease risk.

26. A computer readable medium for implementing a constant volatility index, the index having an associated risk, said computer readable medium comprising:
computer readable instructions for establishing a target level of risk at which to maintain said index;
computer readable instructions for monitoring said level of risk associated with said index; and
computer readable instructions for rebalancing said index by reallocating index components when the risk associated with said index deviates from said target level of risk, thereby at least substantially maintaining a specified risk level.

27. The computer readable medium of claim 26, further comprising computer readable instructions for implementing a risk band to delimit a lower level of risk below said target level of risk and an upper level of risk above said target level of risk of said index, and wherein said computer readable instructions for rebalancing comprises computer readable instructions for rebalancing said index when the risk associated with said index rises above said upper level of risk or drops below said lower level of risk.

28. The computer readable medium of claim 26, wherein said level of risk is measured using at least one of RiskMetric Group's RiskGrade measure, standard deviation, variance, average shortfall, VAR, or any other similar or analogous measures.

29. The computer readable medium of claim 26, wherein said computer readable instructions for rebalancing comprises computer readable instructions for reallocating assets from relatively high risk components of said index to relatively low risk components of said index when the risk associated with said index exceeds said level of risk by a predetermined level.

30. The computer readable medium of claim 26, wherein said computer readable instructions for rebalancing comprises computer readable instructions for reallocating assets from relatively low risk components of said index to relatively high risk components of said index when the risk associated with said index drops below said level of risk by a predetermined level.

31. The computer readable medium of claim 26, wherein said index components comprise at least one security and cash.

32. The computer readable medium of claim 31, wherein said cash is shifted to said at least one security to increase risk.

33. The computer readable medium of claim 31, wherein said at least one security is shifted to said cash to decrease risk.

34. A computer-implemented or assisted method for implementing a constant volatility index, said computer-implemented or assisted method comprising the steps of:
(1) identifying a target level of risk at which to maintain said index;
(2) allocating components in said index in a manner such that a risk associated with said index attains said target level of risk;
(3) setting an acceptable range of risk associated with said target risk (4) monitoring said level of risk associated with said index; and
(5) rebalancing said index by reallocating said components when the risk associated with said index deviates from said acceptable range of risk, thereby at least substantially maintaining a specified risk level.

35. The computer-implemented or assisted method of claim 34, wherein said level of risk is measured using at least one of RiskMetric Group's RiskGrade measure, standard deviation, variance, average shortfall, VAR, or any other similar or analogous measures.

36. The computer-implemented or assisted method of claim 34, wherein said step of ebalancing comprises reallocating assets from relatively high risk components of said index to relatively low risk components of said index, if the risk associated with said index exceeds said level of risk by a predetermined level.

37. The computer-implemented or assisted method of claim 34, wherein said step of rebalancing comprises reallocating assets from relatively low risk components of said index to relatively high risk components of said index, if the risk associated with said index drops below said level of risk by a predetermined level.

38. The computer-implemented or assisted method of claim 34, wherein said index components comprise at least one security and cash.

39. The computer-implemented or assisted method of claim 38, wherein said cash is shifted to said at least one security to increase risk.

40. The computer-implemented or assisted method of claim 38, wherein said at least one security is shifted to said cash to decrease risk.
